(19) United States
(12) Patent Application Publication
(10) Pub. No.: US 2007/0163942 A1
(43) Pub. Date: Jul. 19, 2007

(54) Hollow fiber membrane module

(75) Inventors: Yuji Tanaka, Otsu-shi (JP); Naoki Oka, Otsu-shi (JP); Ichirou Kumo, Koka-shi (JP); Katsumi Yokogawa, Takatsuki-shi (JP); Hiromitsu Kanamori, Kusatsu-shi (JP); Kenji Sakai, Otsu-shi (JP)

Correspondence Address: RATNERPRESTIA, P O BOX 980, VALLEY FORGE, PA, 19482-0980, US

(73) Assignee: Toray Industries, Inc.

(21) Appl. No.: 11/513,645

(22) Filed: Aug. 31, 2006

(30) Foreign Application Priority Data
Jan. 19, 2006 (JP) JP 2006-010773

(51) Int. Cl. B01D 63/02

(52) U.S. Cl. 210/321.89; 210/500.23

(57) ABSTRACT

A hollow fiber membrane module comprising a large number of hollow fiber membranes contained in a cylindrical case, wherein one end of each hollow fiber membrane, which is left open, is fixed to the cylindrical case, while the other ends of the hollow fiber membranes are divided into more than one small bundles, with the ends, contained in separate small bundles, being kept together and plugged.

### BACKGROUND

1. Field of the Invention

The invention relates to a hollow fiber membrane module that is useful for water purification, and more specifically, it relates to a hollow fiber membrane module that is free of serious deterioration in filtration ability when used for filtration and has a special structure that permits a high production efficiency in module production.

The invention furthermore relates to a submerged type hollow fiber membrane module, which is immersed in a reservoir containing raw water in order to filter the raw water, and more specifically, it relates to a hollow fiber membrane module that maintains a high filtration ability for a long period of time and serves to decrease the air flow used to air-scrub the hollow fiber membranes which will lead to cost reduction.

2. Related Art

Conventionally, hollow fiber membrane modules have been widely used for raw water filtration to provide drinking water and industrial water.

Conventional hollow fiber membrane modules are described in, for instance, JP 3290815, JP 07-060074 A, JP 59-004403 A, or JU 60-115502 A and its specification.

FIGS. 7 and 8 show schematic cross-sections of typical conventional hollow fiber membrane modules. In FIG. 7, a hollow fiber membrane module 101 includes a cylindrical case 103 and a hollow fiber membrane bundle comprising a large number of hollow fiber membranes 102. In the hollow fiber membrane module 101, one end portion (top end portion) of each hollow fiber membrane 102, which is open at the end, is fixed to the cylindrical case 103 with synthetic polymer resin (top end plate) 104a. The other end portion (bottom end portion) of each hollow fiber membrane 102, which is plugged at the end, is fixed to the cylindrical case 103 with synthetic polymer resin (bottom end plate) 104b.

A bottom cap 107 is provided at the bottom end of the cylindrical case 103, and a raw water inlet port 112 is provided in the bottom cap 107. The bottom end plate 104b has vent holes (air diffuser holes) 110 to allow raw water and cleaning air to pass through. A top cap 106 is provided at the top end of the cylindrical case 103, and a permeate outlet port 113 is provided in the top cap 106. A concentrated water outlet port 114 is provided in the top end portion of the case wall of the cylindrical case 103.

In FIG. 8, a hollow fiber membrane module 201 includes a cylindrical case 203 and a hollow fiber membrane bundle comprising a large number of hollow fiber membranes 202. In the hollow fiber membrane module 201, one end portion (top end portion) of each hollow fiber membrane 202, which is open at the end, is fixed to the cylindrical case 203 with synthetic polymer resin (top end plate) 204. The other end portion (bottom end portion) of the hollow fiber membranes 202 is not fixed to the cylindrical case 203, and the end of each hollow fiber membrane 202 is individually closed, for example, with a plugging material 211. Thus, the bottom end of each hollow fiber membrane 202 can swing freely.

A bottom cap 207 is provided at the bottom end of the cylindrical case 203, and a raw water inlet port 212 is provided in the bottom cap 207. A bottom end plate (air diffuser plate) 209 that has vent holes (air diffuser holes) 210 to allow raw water and cleaning air to pass through is provided at the bottom end of the cylindrical case 203. A top cap 206 is provided at the top end of the cylindrical case 203, and a filtered water outlet port 213 is provided in the top cap 206. A concentrated water outlet port 214 is provided in the top end portion of the case wall of the cylindrical case 203.

When such hollow fiber membrane modules 101 and 201 are used for external pressure type filtration, the hollow fiber membrane modules 101 and 201 are generally placed vertically. Through the inlet ports 112 and 212 in the bottom cap 107 and 207 of the hollow fiber membrane module 101 and 201, raw water (water to be treated) is fed into the hollow fiber membrane modules, and then the raw water penetrates the hollow fiber membranes 102 and 202 from their outer surface and comes into the hollow space as permeate. The permeate passes through the outlet port 113 and 213 in the top cap 106 and 206 and comes out from the hollow fiber membrane module 101 and 201.

As more raw water continues to be filtered, particulate matter in the raw water accumulates over the outer surface of the hollow fiber membranes, and the filtration resistance increases, leading to a gradual decrease in a water flux of the membrane. To recover the low filtration resistance state, the supply of raw water is stopped, and the permeate is fed through the top cap 106 and 206 into the hollow space of the hollow fiber membranes to perform back washing of the hollow fiber membranes. At the same time with the back washing, air is supplied through the bottom cap 107 and 207 to the outside of the hollow fiber membranes 102 and 202 to perform air scrubbing of the hollow fiber membranes. The combination of the back washing and air scrubbing serves to remove the particulate matter from the outer surface of the hollow fiber membranes and discharge it with water from the cylindrical case 103 and 203 through the bottom cap 107 and 207.

Submerged type hollow fiber membrane modules as described in JP 2002-346344 A are well known, in which the hollow space of the hollow fiber membranes has a negative pressure to accelerate filtration. FIG. 12 shows a schematic cross-section of a typical submerged type hollow fiber membrane module. In FIG. 12, a hollow fiber membrane module 301 comprises a cylindrical case 317 and a hollow fiber membrane bundle comprising a large number of hollow fiber membranes 302. In the hollow fiber membrane module 301, one end portion (top end portion) of each hollow fiber membrane 302, which is open at the end, is fixed to the cylindrical case 317 with synthetic polymer resin (top end plate) 304a. The other end portion (bottom end portion) of each hollow fiber membrane 302, which is plugged at the end, is fixed to the cylindrical case 317 with synthetic polymer resin (bottom end plate) 304b.

A bottom cap 307 is provided at the bottom end of the cylindrical case 317, and a raw water inlet port 312 is provided in the bottom cap 307. The bottom end plate 304b has vent holes (air diffuser holes) 310 to allow raw water and cleaning air to pass through. A top cap 306 is provided at the top end of the cylindrical case 317, and a permeate outlet port 313 is provided in the top cap 306. The case wall of the cylindrical case 317 has openings 318 to allow raw water to move between inside and outside of the cylindrical case 317.

When the hollow fiber membrane module 301 is immersed in raw water, the raw water passes through the openings 318 of the cylindrical case 317 and flows to the hollow fiber membranes 302. The raw water moves from the outer surface of the hollow fiber membranes 302 into the hollow space where is kept in a negative pressure and permeate is produced therein. The permeate is taken out through the outlet port 313 of the top cap 306.

As in the case of the external pressure type filtration described above, as more raw water continues to be filtered in the submerged type hollow fiber membrane module 301, particulate matter in the raw water accumulates over the outer surface of the hollow fiber membranes and the filtration resistance increases, leading to a gradual decrease in a water flux of the membrane. To recover the low filtration resistance state, air is supplied through the inlet port 312 of the bottom cap 307 to the outside of the hollow fiber membranes 302 to perform air scrubbing of the hollow fiber membranes. The air scrubbing serves to remove the particulate matter from the surface of the hollow fiber membranes and discharge it through the vent holes 310 or the openings 318 of the cylindrical case 317.

In hollow fiber membrane modules as described in FIGS. 7 and 12, however, air for air scrubbing of the hollow fiber membranes, which has introduced through the inlet ports 112 and 312 of the bottom caps 107 and 307, gets in the filtration region through a plurality of the vent holes (air diffuser holes) 110 and 310 provided in the bottom end plates 104b and 304b, and the ends of the hollow fiber membranes 102 and 302 are held by the top end plates 104a and 304a and the bottom end plates 104b and 304b, making the hollow fiber membranes 102 and 302 unable to move freely and making it difficult for all portions of the hollow fiber membranes, including those near the top end plates 104a and 304a and the bottom end plates 104b and 304b, to be air-scrubbed completely. Furthermore, particulate matter removed from the outer surface of the hollow fiber membranes is discharged with water through the air diffuser holes 110, or the air diffuser holes 310 of a submerged type module, and the openings 318 of the cylindrical case 317, but particulate matter that has fallen between air diffuser holes tends to stay on the top surface of the bottom end plates 104b and 304b and is difficult to remove completely.

In the case of a hollow fiber membrane module as described in FIG. 8, on the other hand, the bottom ends of each hollow fiber membrane, which is not fixed by an end plate etc., can move freely, independent to each other, as a result of raw water flow during filtration and air scrubbing, serving effectively for prevention of particulate matter accumulation. However, troublesome and time-consuming work is necessary to close the ends of a large number of hollow fiber membranes. In addition, it is seen that the flow rate of raw water in the cylindrical case tends not to be uniform and, if not uniform actually, particular portions of the hollow fiber membranes tend to move more heavily than necessary and hit other hollow fiber membranes, resulting in damage to hollow fiber membranes. During air scrubbing, furthermore, the flow of air tends not to be uniform and, if not uniform actually, the hollow fiber membranes tend not to be swung uniformly for particulate matter removal, or hollow fiber membranes, which can swing freely, may get tangled.

A hollow fiber membrane module as disclosed in JP 2002-346344 A described above has a cylindrical case (circumferential wall) in the central portion in the length direction, but with this structure, the hollow fiber membranes, above and below the cylindrical case, are directly exposed to the raw water in the reservoir. This structure is preferred for removal of particulate matter because hollow fiber membranes are directly exposed to the raw water at top and bottom portions of the hollow fiber membranes, where particulate matter tends to accumulate.

In this structure, however, air for air scrubbing supplied from the bottom of the hollow fiber membrane module tends to get out through bottom end portions of the hollow fiber membranes where hollow fiber membranes are exposed, and flow out of the hollow fiber membrane module, failing to allow the top portions if the hollow fiber membranes to swing adequately and resulting in inadequate removal of particulate matter from the outer surface of the hollow fiber membranes.

Thus, it is difficult for conventional hollow fiber membrane module structures to simultaneously enhance both the removal of particulate matter and the washing of the hollow fiber membranes.

### BRIEF SUMMARY OF THE INVENTION

The object of the invention is to provide a hollow fiber membrane module wherein the hollow fiber membranes swing moderately without hitting each other during the filtration step and air scrubbing step, that particulate matter removed from the outer surface of the hollow fiber membranes can be easily discharged during the air scrubbing step, and that the ends of the hollow fiber membranes can be easily closed during the hollow fiber membrane module production step.

To meet the above object, the hollow fiber membrane module of the invention is as follows:

A hollow fiber membrane module, which comprises a hollow fiber membrane bundle comprising a large number of hollow fiber membranes, contained in a cylindrical case, wherein one end portion of the hollow fiber membrane bundle is fixed to the cylindrical case in a state that each end of the hollow fiber membrane is open, while at the other end portion of the hollow fiber membrane bundle, the large number of hollow fiber membranes are divided into small bundles, with each small bundle being composed of a plurality of the hollow fiber membranes, and with a small bundle forming member being provided at the end portion of each of the small bundles in order to bundle and fix the hollow fiber membranes and close the end of each of the hollow fiber membranes.

For the hollow fiber membrane module of the invention, the number of the small bundles is preferably in the range of 10 to 800.

For hollow fiber membrane module of the invention, it is preferred that the diameter of the modules is in the range of 50 to 400 mm, that the length of the modules is in the range of 500 to 3000 mm, and that the number of the hollow fiber membranes contained in each small bundle is in the range of 50 to 800.

For the hollow fiber membrane module of the invention, it is preferred that a turbulence generation member is provided on a surface of the small bundle forming member.

For the hollow fiber membrane module of the invention, it is preferred that a small bundle partition member is provided in the cylindrical case, and each of the small bundle forming members is compartmentalized by the small bundle partition member.

For the hollow fiber membrane module of the invention, it is preferred that at least one hanging string is provided along with the hollow fiber membranes forming each of the small bundles, wherein one end of the hanging string is fixed at the cylindrical case together with the one ends of the hollow fiber membranes and the other end of the hanging string is fixed at the small bundle forming member together with the hollow fiber membranes forming the small bundle, and wherein in each of the small bundle a length of the hanging string in a filtration area is shorter than the shortest length of the hollow fiber membrane among lengths of the hollow fiber membranes in the filtration area.

For the hollow fiber membrane module of the invention, it is preferred that the cylindrical case has an opening to allow water to move between inside and outside thereof. A module in this type is called a submerged type module.

For the hollow fiber membrane module of the invention, it is preferred that the opening is formed by providing porous material in at least parts of the circumferential wall of the cylindrical case and that the average rate of hole area in the lower portion of the circumferential wall of the cylindrical case is 25% or less.

For the hollow fiber membrane module of the invention, it is preferred that the average rate of hole area in the upper portion of the circumferential wall of the cylindrical case is larger than the average rate of hole area in the lower portion of the circumferential wall.

For the hollow fiber membrane module of the invention having the opening in the cylindrical case, it is preferred that the number of the small bundles is in the range of 3 to 50, and that the number of hollow fiber membranes in each of the small bundle is in the range of 50 to 2000.

According to the hollow fiber membrane module of the invention, a large number of hollow fiber membranes are divided into several small bundles at one end, which is generally the bottom end during use, and their ends, put together in each bundle, are closed, which allows each small bundle of hollow fiber membranes to swing moderately during the filtration and air scrubbing processes, facilitating the prevention of particulate matter accumulation and efficient removal of the particulate matter.

It is also possible to use a relatively large flow path for water discharge from the back washing process, allowing the water discharge to be completed in a short period of time. In addition, the end plugging member (small bundle forming member) in each small bundle acts as a weight, serving to maintain the position of each small bundle at a roughly fixed point if raw water and air flow between there. This prevents the hollow fiber membranes from swinging more heavily than necessary to cause damage to each other or get tangled. Furthermore, the ends of the hollow fiber membranes that are at the bottom during use are not fixed to the cylindrical case, allowing particulate matter removed from the outer surface of the hollow fiber membranes to be easily discharged during the air scrubbing process and facilitating the plugging of the ends of the hollow fiber membranes, which increases the productivity, because it is only necessary to put a small bundle of hollow fiber membranes together and plug their ends.

According to the hollow fiber membrane module of the invention, the rate of hole area in the lower portion of the circumferential wall of the cylindrical case is 25% or less, which allows the air for air scrubbing supplied from below the hollow fiber membrane module to be used effectively, without flowing out through the opening provided in the cylindrical case to the outside of the hollow fiber membrane module, for the swinging of the hollow fiber membranes and also allows particulate matter to be discharged efficiently from both the top and bottom ends of the hollow fiber membrane module, serving to use the hollow fiber membranes for a long period of time without deterioration of their filtration ability.

### BRIEF DESCRIPTION OF THE DRAWINGS

FIG. 1 shows a schematic cross-section of an embodiment of a hollow fiber membrane module of the invention.

FIG. 2 shows an enlarged perspective view of the bottom end portion of an embodiment of the small bundle shown in FIG. 1.

FIG. 3 shows a schematic cross-section of another embodiment of a hollow fiber membrane module of the invention.

FIG. 4 shows a schematic cross-section of still another embodiment of a hollow fiber membrane module of the invention.

FIG. 5 shows a schematic cross-section of the lower portion of an embodiment of a hollow fiber membrane module of the invention.

FIG. 6 shows a top view of the small bundle partition member shown in FIG. 5.

FIG. 7 shows a schematic cross-section of a conventional hollow fiber membrane module.

FIG. 8 shows a schematic cross-section of another conventional hollow fiber membrane module.

FIG. 9 shows an enlarged perspective view of another embodiment of the bottom end portion of a small bundle shown in FIG. 1.

FIG. 10 shows an enlarged perspective view of still another embodiment of the bottom end portion of a small bundle shown in FIG. 1.

FIG. 11 shows a schematic cross-section of still another embodiment of a hollow fiber membrane module of the invention.

FIG. 12 shows a schematic cross-section of a conventional submerged type hollow fiber membrane module.

FIG. 13 shows a schematic cross-section of an embodiment of a submerged type hollow fiber membrane module of the invention.

FIG. 14 shows a schematic cross-section of another embodiment of a submerged type hollow fiber membrane module of the invention.

FIG. 15 shows a development of the circumferential wall of a cylindrical case shown in FIG. 14.

FIG. 16 shows an enlarged view of a portion of the circumferential wall shown in FIG. 15.

FIG. 17 shows a schematic cross-section of still another embodiment of a submerged type hollow fiber membrane module of the invention.

FIG. 18 shows a schematic cross-section of still another embodiment of a submerged type hollow fiber membrane module of the invention.

FIG. 19 shows a schematic cross-section of still further another embodiment of a submerged type hollow fiber membrane module of the invention.

FIG. 20 shows a development of the circumferential wall of a cylindrical case shown in FIG. 19.

FIG. 21 shows a schematic cross-section of another embodiment of a submerged type hollow fiber membrane module of the invention.

### DETAILED DESCRIPTION OF THE INVENTION

The hollow fiber membrane module of the invention is illustrated below with reference to examples where it is used in filtrating raw water for producing clean water. The hollow fiber membrane module of the invention, however, is not limited to the use for producing clean water but may also be used for producing industrial water and treating sewage water.

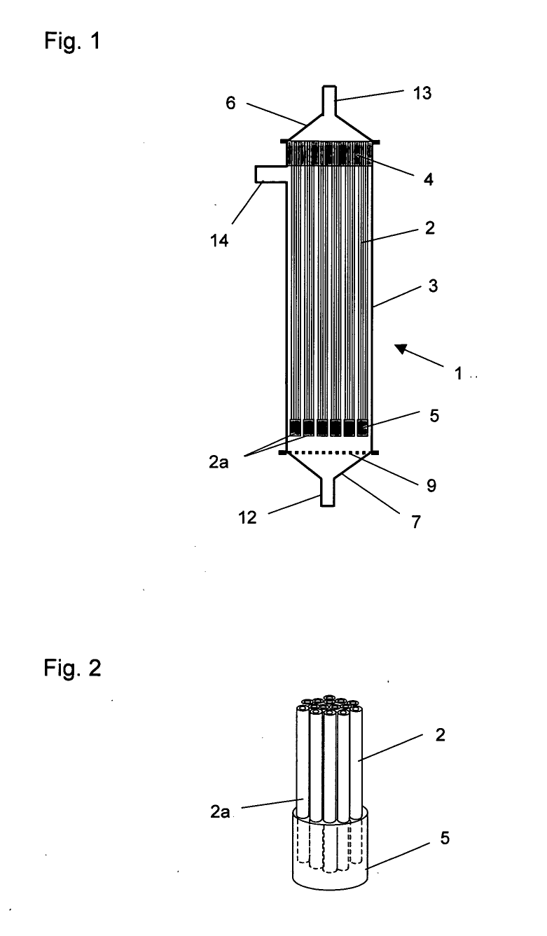

FIG. 1 shows a schematic cross-section of an embodiment of a hollow fiber membrane module of the invention.

In FIG. 1, the hollow fiber membrane module 1 of the invention has a cylindrical case 3, with both ends being open, and a hollow fiber membrane bundle comprising a large number of hollow fiber membranes 2 which is inserted in the cylindrical case 3. The top end portions of the hollow fiber membranes 2 are fixed in a watertight manner to the top end of the cylindrical case 3 with synthetic polymer resin (top end plate) 4, wherein the end of each hollow fiber membrane 2 is open. At the bottom end portions of hollow fiber membranes 2, on the other hand, the large number of hollow fiber membranes 2 is divided into small bundles 2a, each containing 10 to 800 hollow fiber membranes. Thus, each small bundle 2a comprises a plurality of hollow fiber membranes. A plugging member (small bundle forming member) 5 is provided at the end of each small bundle 2a. The hollow fiber membranes 2 in each small bundle 2a are bundled and fixed with a small bundle forming member 5, and further, the end of each hollow fiber membrane 2 is plugged with the small bundle forming member 5.

With this structure, the large number of hollow fiber membranes 2 can swing in a unit of the small bundles 2a at the bottom end. The hollow fiber membranes may be bent in a U shape, with the bottom end portion, where the hollow fiber membranes are bent, being fixed with a small bundle forming member 5, if the bottom end portions of the hollow fiber membranes can move in bundles freely. In this structure, the hollow space in the hollow fiber membranes is not actually plugged with a small bundle forming member 5 at the bent bottom end portion of the hollow fiber membranes, but the bottom end portion of the hollow fiber membranes is assumed to be plugged with a small bundle forming member 5 in the present specification on the grounds that the permeate in the hollow space in the hollow fiber membranes cannot leak from the bottom end portion of the hollow fiber membranes.

A top cap 6 having a permeate outlet (outlet port) 13 is connected in a watertight manner to the top of the cylindrical case 3. A bottom cap 7 that has a raw water and air inlet (inlet port) 12 and holds an air diffuser plate 9 is connected in a watertight manner to the bottom of the cylindrical case 3. The watertight connection can be generally achieved by using packing with sanitary clamps to hold it.

The inlet port 12 in the bottom cap 7 is joined to a raw water supply pipe (not shown in the figure) that is connected to the raw water source via a raw water supply pump, air supply pipe (not shown in the figure) that is connected to a pressurized air source via an air valve, and a drainage pipe (not shown in the figure) that has a first drainage valve. The permeate outlet port 13 in the top cap 6 is joined to a permeate discharge pipe (not shown in the figure) that has a permeate valve. Further, an air outlet port 14 for air scrubbing is provided in the upper portion of the circumferential wall of the cylindrical case 3, and the outlet port 14 is joined to a water discharge pipe (not shown in the figure) via a second drainage valve.

FIG. 13 shows a schematic cross-section of an embodiment of a submerged type hollow fiber membrane module of the invention. In FIG. 13, the submerged type hollow fiber membrane module 21 of the invention has a cylindrical case 17 and a hollow fiber membrane bundle comprising a large number of hollow fiber membranes 22 which is inserted in the cylindrical case 17. The top end portions of the hollow fiber membranes 22 are fixed to the top end of the cylindrical case 17 with synthetic polymer resin (top end plate) 24, wherein the end of each hollow fiber membrane 22 is open. At the bottom end portions of hollow fiber membranes 22, on the other hand, the large number of hollow fiber membranes 22 is divided into small bundles 22a. Each small bundle 22a comprises a plurality of hollow fiber membranes. A small bundle forming member 25 is provided at the end of each small bundle 22a. The hollow fiber membranes 22 in each small bundle 22a are bundled and fixed with a plugging member (small bundle forming member) 25, and further, the end of each hollow fiber membrane 22 is plugged, with the plugging member (small bundle forming member) 25. With this structure, the large number of hollow fiber membranes 22 can swing in a unit of the small bundles 22a at the bottom end portions.

A top cap 26 having a permeate outlet (outlet port) 33 is connected in to the top of the cylindrical case 17. A bottom cap 27 that has a raw water and air inlet (inlet port) 32 and holds an air diffuser plate 29 is connected to the bottom of the cylindrical case 17.

The inlet port 32 in the bottom cap 27 is joined to an air supply pipe (not shown in the figure) that is connected to a pressurized air source via an air valve and a drainage pipe (not shown in the figure) that has a first drainage valve. The permeate outlet port 33 in the top cap 26 is joined to a permeate discharge pipe (not shown in the figure) via a suction pump and a permeate valve.

Materials preferably used to forming the cylindrical case for the hollow fiber membrane module of the invention include polyolefin resins such as polyethylene, polypropylene and polybutene; fluorocarbon resins such as polytetrafluoroethylene (PTFE), tetrafluoroethylene-perfluoroalkoxyethylene copolymers (PFA), tetrafluoroethylene-hexafluoropropylene copolymers (FEP), tetrafluoroethylene-ethylene copolymers (ETFE), polytrifluorochloroethylene resin (PCTFE), ethylene-chlorotrifluoroethylene (ECTFE) and polyvinylidene fluoride (PVDF); chlorine-based resins such as polyvinyl chloride and polyvinylidene chloride; and other resins such as polysulfone resin, polyethersulfone resin, polyarylsulfone resin, polyphenylether resin, acrylonitrile-butadiene-styrene copolymer resin (ABS), acrylonitrile-styrene copolymer resin, polyphenylene sulfideresin, polyamide resin, polycarbonateresin, polyetherketone resin and polyetheretherketone resin; which may be used alone or in combination. In addition to these resins, aluminum and stainless steel may also be used preferably, and furthermore, resin-metal composites and other composites such as glass fiber reinforced resin and carbon fiber reinforced resin are also preferred.

Openings 28 are provided in the circumferential wall of the cylindrical case 17 to allow raw water to flow through the wall. The cylindrical case 17 having the openings 28 may be made of net-like or grid-like material that has openings to allow water and air to pass.

There are no specific limitations on materials of the hollow fiber membranes to be used in the hollow fiber membrane module of the invention, and preferred materials include polysulfone, polyethersulfone, polyacrylonitrile, polyimide, polyetherimide, polyamide, polyetherketone, polyetheretherketone, polyethylene, polypropylene, ethylene-vinylalcohol copolymers, cellulose, cellulose acetate, polyvinylidene fluoride, ethylene-tetrafluoroethylene copolymers and polytetrafluoroethylene, which my be combined into composites.

For the hollow fiber membrane module of the invention, there are no particular requirements for the small bundles if they comprise a plurality of hollow fiber membranes to perform desired swinging motions, depending on features of the module such as the diameter and length of the cylindrical case and the structures of the raw water and air inlets. Where the diameter of the module. (the diameter of the cylindrical case) is in the range of about 50 to 400 mm and the length of the module (the length of the cylindrical case) is in the range of about 500 to 3000 mm, it is preferable that the number of the hollow fiber membranes is in the range of 50 to 2000, more preferable in the range of 50 to 800, further preferable in the range of 100 to 500. The number of small bundles contained in a cylindrical case is preferably in the range of 3 to 1000, more preferably in the range of 3 to 50. The total number of hollow fiber membranes contained in a cylindrical case is generally in the range of several hundreds to several thousands.

For the hollow fiber membrane module of the invention, the synthetic polymer resin (top end plate) used to fix the hollow fiber membranes to the cylindrical case may be made of such materials as epoxy, polyurethane and epoxy acrylate resins. In the hollow fiber membrane module of the invention, the hollow fiber membranes can swing through larger angles than in a module in which both ends of hollow fiber membranes are fixed to the cylindrical case, and therefore it is preferred that the top end plate has a two-layer structure made of two types of synthetic polymer resin to prevent the hollow fiber membranes from being damaged below or near the top end plate. Thus, the portion of the top end plate that faces the filtration area of the hollow fiber membranes, for instance, may be made of an elastic material such as silicone resin and urethane resin.

The plugging member (small bundle forming member) used in the hollow fiber membrane module of the invention is preferably made of resin in view of the role to bundle a plurality of hollow fiber membranes and plug their ends. Preferred resins include thermosetting ones such as epoxy resin, urethane resin, epoxy acrylate resin, silicone resin and polyester resin, and a variety of thermoplastic one such as polyethylene, polypropylene, and the material used in the hollow fiber membranes. Resin to be used preferably has a type A durometer hardness of about 5 to 95 according to JIS-K6253 (2004) in order to prevent damage to the hollow fiber membranes in areas where the plugging members (small bundle forming members) contact with the hollow fiber membranes. It is also preferred that a layer of resin with the hardness is provided over another resin layer with a higher hardness. The durometer hardness according to JIS-K6253 (2004) is measured with a measuring instrument as described in JIS-K6253 (2004) by pressing the stylus against the surface of the resin. If it is impossible to perform the pressing operation, a sample may be prepared to be used for the measurement.

The plugging member (small bundle forming member) to be used in the hollow fiber membrane module of the invention may be in various shapes depending on the packing density of hollow fiber membranes in the cylindrical case and the size of the space between the small bundles.

FIG. 2 shows an enlarged perspective view of a small bundle 2a in the hollow fiber membrane module 1 of the invention shown in FIG. 1. In FIG. 2, the plugging member (small bundle forming member) 5 of the small bundle 2a has a columnar shape.

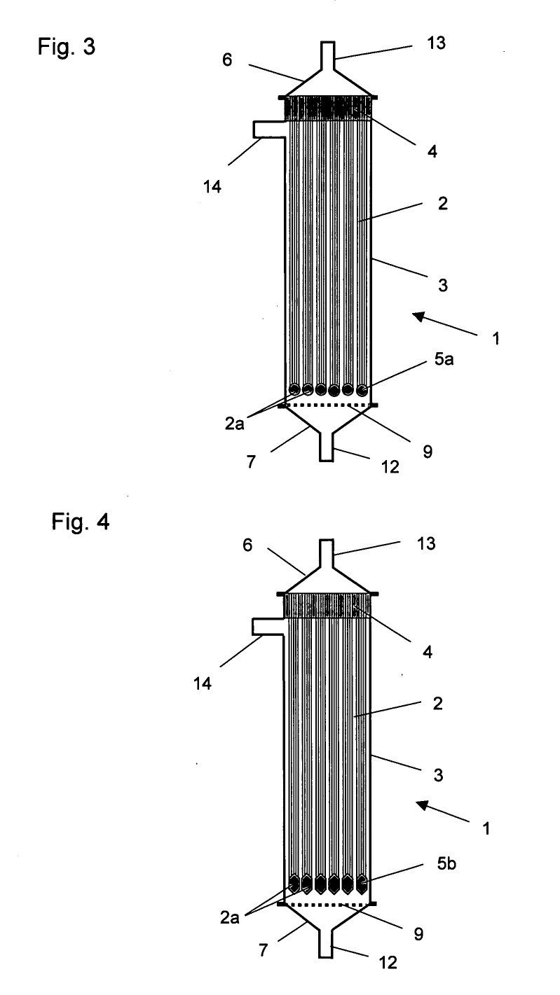

FIG. 3 shows a schematic cross-section of another embodiment that is different from the hollow fiber membrane module 1 of the invention shown in FIG. 1. The only difference between the module in FIG. 1 and that in FIG. 3 is the shape of the small bundle forming member. Therefore, the overall feature of the module in FIG. 3 is not described here, but the bundling member 5a in the module in FIG. 3 has a spherical shape.

FIG. 4 shows a schematic cross-section of another embodiment that is different from the hollow fiber membrane module 1 of the invention shown in FIG. 1. The only difference between the module in FIG. 1 and that in FIG. 4 is the shape of the small bundle forming member. Therefore, the overall feature of the module in FIG. 4 is not described here, but the bundling member 5b in the module in FIG. 4 has a spindle-like shape.

Other small bundle forming members may have a conical, pyramid or plate-like shape. Among the columnar ones, those with a circular cross-section (cylinders) are preferred because they can be molded easily, but are not broken easily. The cross-section of the columnar ones may also be a polygon such as triangle, quadrangle, pentagon or hexagon, or other shapes such as ellipse and star.

FIG. 10 shows an enlarged perspective view of another embodiment that is different from the small bundle forming member 5 shown in FIG. 2. In FIG. 10, the small bundle forming member 5c has a columnar body with a circular cross-section (cylinder), but the bottom has a hemispherical shape. In addition, the small bundle forming member 5c has turbulence generation members 16 provided on some parts of the circumferential wall of the columnar body. The turbulence generation members 16 comprise wings and spiral grooves provided on the surface of the small bundle forming member 5c. A module having small bundle forming members with turbulence generation member 5c is used preferably to filter raw water containing a large amount of particulate matter, because raw water and air hit the turbulence generation members to cause small vibration and swinging motions of the small bundles.

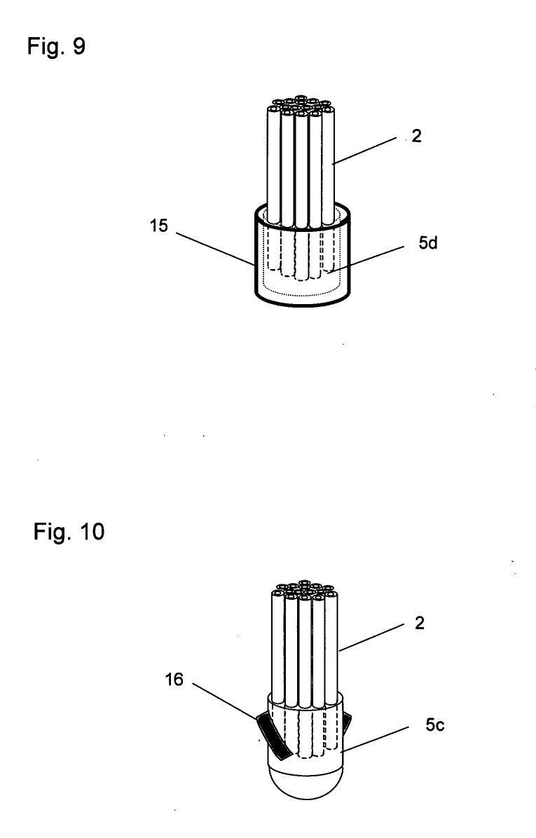

FIG. 9 shows an enlarged perspective view of another embodiment that is different from the small bundle forming member 5 shown in FIG. 2. In FIG. 9, the small bundle forming member 5d has a columnar body with a circular cross-section (cylinder). The small bundle forming member 5d comprises a metal container 15 that contains resin, and the resin serves to bundle a plurality of hollow fiber membranes 2 and plug their ends. The small bundle forming member 5d is produced by arranging the ends of more than one hollow fiber membrane 2 in the metal container 15, and inject rein, followed by solidification of the resin to fix the hollow fiber membranes 2 and plug their ends. This small bundle forming member production method serves for effective plugging of the ends of the hollow fiber membranes, with the metal container 15 acting as a metal weight for the hollow fiber membranes 2 hanging in the module. The metal container 15 is preferably made of stainless steel (SUS).

To prevent a decrease in a packing density of the hollow fiber membranes in the cylindrical case caused by existence of the plugging members (small bundle forming members), it is preferred that each plugging member (small bundle forming member) is shifted relative to its neighbor in the direction of the axis of the module (vertical direction).

Part of each plugging member (small bundle forming member) may be connected to neighboring plugging member (small bundle forming member). Such connection may be achieved with a rod or a string. This connection, which serves to join all plugging members (small bundle forming members), prevent only those plugging members (small bundle forming members) located in a certain area from swinging, and works to propagate the vibration and swinging motions all other plugging members (small bundle forming members). At the same time, the position of each small bundle can be controlled moderately. This enhances the dispersion of raw water and air. An enhanced dispersion serves to facilitate the prevention of contamination on hollow fiber membranes and prevention of entanglement of small bundles.

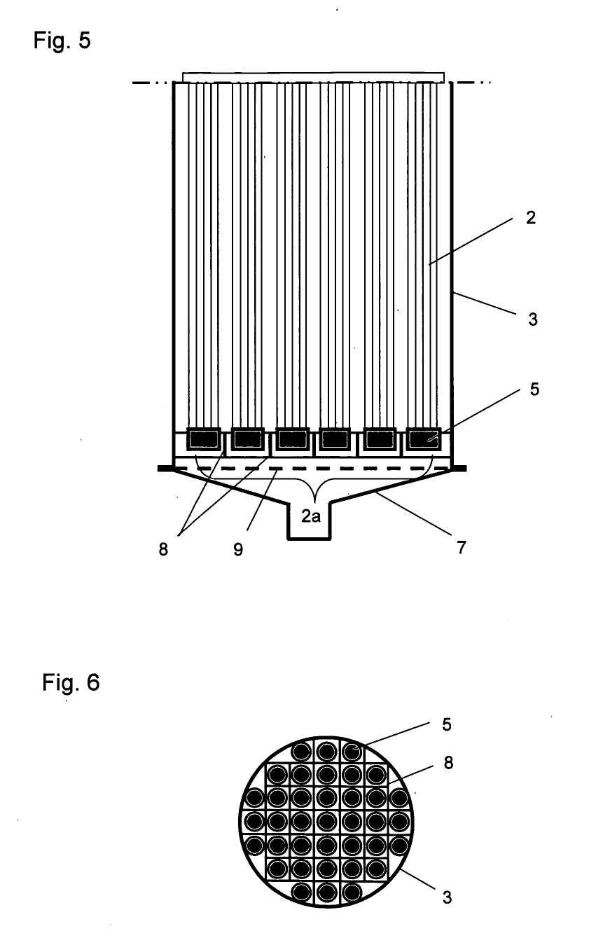

FIG. 5 shows a schematic cross-section of the lower portion of another embodiment that is different from the hollow fiber membrane module of the invention shown in FIG. 1. The only difference between the module in FIG. 1 and that in FIG. 5 is that small bundle partition members 8 are provided between the small bundles 2a in the module in FIG. 5. The overall feature of the module shown in FIG. 5 is therefore not described here.

In FIG. 5, bundle partition members 8 are provided between the small bundles 2a at positions that correspond to the plugging members (small bundle forming members) 5 in the cylindrical case 3. FIG. 6 shows a top view of the bundle partition member 8 shown in FIG. 5. The bundle partition members 8 comprise partition plates arranged in a grid-like manner in the cylindrical case 3. Each space partitioned by the plates contains a plugging member (small bundle forming member) 5 for a small bundle. The bundle partition members 8 serve to control the position of each small bundle moderately. This enhances the dispersion of raw water and air. An enhanced dispersion serves to facilitate the prevention of contamination on hollow fiber membranes and prevention of entanglement of small bundles. There are no specific limitations on the material of the bundle partition members 8, but in view of the fitting of the bundle partition members 8 and their future disposal, it is preferred that the material is the same as that of the cylindrical case.

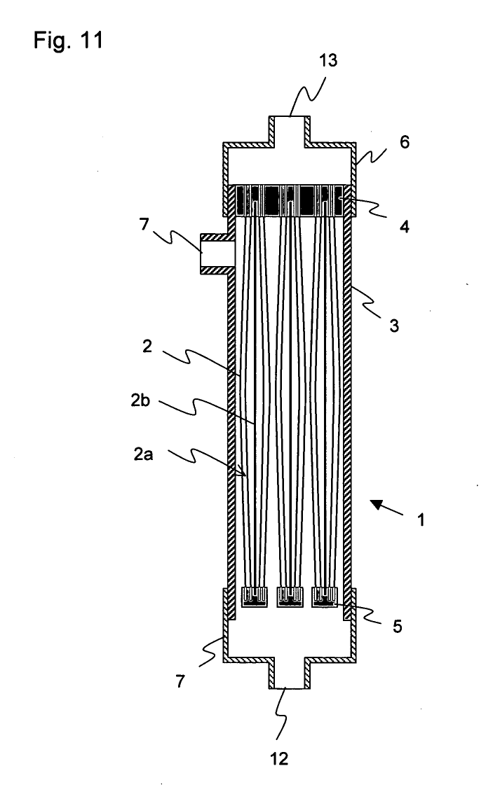

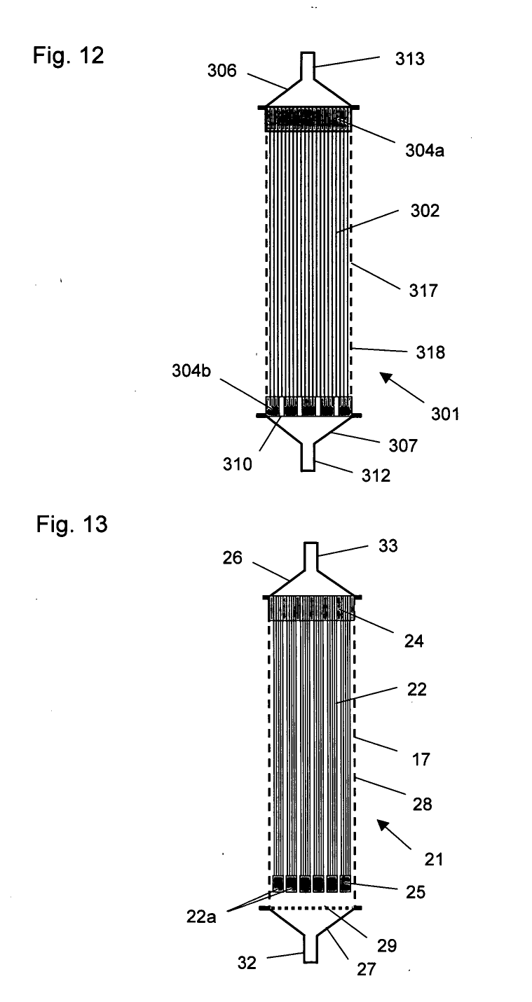

FIG. 11 shows a schematic cross-section of another embodiment that is different from the hollow fiber membrane module shown in FIG. 1. The great difference between the module in FIG. 1 and that in FIG. 1 is that the module in FIG. 11 has at least one string provided along with hollow fiber membranes forming each of small bundles. Still, the module in FIG. 1 has no air diffuser plate such as the air diffuser plate 9 in the module shown in FIG. 1. Further, though the bottom cap 7 and the top cap 6 in the module shown in FIG. 11 and the top cap 6 in the module shown in FIG. 1 are different from each other in their shapes, their functions are the same. Therefore, the overall feature of the module in FIG. 11 is not described here.

The module 1 shown in FIG. 11 is an embodiment improved on the module 1 shown in FIG. 1. In case of the module shown in FIG. 1, if there is a hollow fiber membrane having shorter length comparing to lengths of other hollow fiber membranes between the bottom face of the top end plate 4 and the top face of the small bundle forming member 5, that is, length in the filtration area, it happens that the hollow fiber membrane having the shorter length bears almost or all of weight of the small bundle forming member 5.

Such state brings a break of the hollow fiber membrane having the shorter length or there is the possibility that the break spreads to a break of another hollow fiber membrane. If a break of a hollow fiber membrane happens, a problem of flowing raw water into the side of permeate through the broken hollow fiber membrane is brought. On the other hand, it is not easy to produce a hollow fiber membrane module in such that all of the lengths of hollow fiber membranes in several tens to several thousands in a filtration area are the same each other.

For solving the problem, at least one hanging string 2b is provided along with hollow fiber membranes forming each of small bundles 2a in a module 1 shown in FIG. 11. One end of the hanging string 2b is fixed together with one ends of the hollow fiber membranes 2 in the top end plate 4a secured with the cylindrical case, and the other end is fixed together with the hollow fiber membranes 2 in the small bundle 2a in the small bundle forming member 5. The length of the hanging string 2b fixed with the both ends between the bottom face of the top end plate 4 and the top face of the small bundle forming member 5, that is, the length in the filtration area is determined such that the length is shorter than the length of a hollow fiber membrane which is the shortest in the filtration area. Both lengths of the hollow fiber membranes 2 and the hanging string 2b are determined respectively in straight.

A burden of weight in a hollow fiber membrane having short length is reduced or becomes none by the hanging string 2b, and a break of the hollow fiber membrane caused by an excessive burden of weight is prevented. Of course, for the sake, it is necessary that the resistance for weight of the hanging string 2b is larger than that of the hollow fiber membrane.

The hanging string 2b is formed by, for example, a thread or rod. As the thread, there is, for example, a metal wire, a natural or synthetic resin fiber, or a metal or resin tube, and as the rod, there is, for example, a metal rod, a natural or synthetic resin rod, or a metal or resin tube. As the resin, there is, for example, polyethylene resin, polypropylene resin, polyvinyl chloride resin, or acrylic resin. As the metal, there is, for example, stainless steel, or aluminum. Where the hanging string is made of a tube, it is preferable that the ends of the tube is sealed to prevent flowing raw water into the side of permeate in by any chance of a break of the tube. Further, it is preferable that at least two hanging strings 2b are provided in each of the small bundle forming member 2a. On that case, even if one hanging string is fallen away from the top end plate 4a or the small bundle forming member 4b, it is possible to prevent a break of the hollow fiber membrane effectively with another hanging string.

The procedure for using the hollow fiber membrane module 1 in FIG. 1 is described below.

In the filtration process, the air supply valve, the first drainage valve and the second drainage valve are closed and the permeate valve is opened, followed by starting the raw water supply pump to allow raw water flow from the inlet port (the inlet port) 12 into the hollow fiber membrane module 1 and allow the permeate to flow out from the permeate outlet (the outlet port) 13 to the permeate discharge pipe.

As the filtration proceeds, particulate matter in raw water accumulates on the outer surface of the hollow fiber membranes 2 to increase the filtration resistance in the hollow fiber membranes 2, leading to a decrease of the water flux of the membrane. So, back washing and air scrubbing are performed.

For back washing, the raw water supply pump is stopped and the first drainage valve and the permeate valve are closed while the second drainage valve is opened, followed by keeping the permeate valve opened for a required time to allow the water to flow from the inside (hollow space) to the outer surface of the hollow fiber membranes 2, i.e. in the reverse direction to that in the filtration process. In general, permeate that has been produced is used for back washing.

For air scrubbing, the raw water supply pump is stopped and the first drainage valve and the permeate valve are closed while the second drainage valve is opened, followed by keeping the air supply valve opened for a required time to allow air to flow into the hollow fiber membrane module 1.

Drainage is performed after the back washing and air scrubbing. For the drainage, the raw water supply pump is stopped and the second drainage valve is opened, followed by opening the first drainage valve to allow water in the hollow fiber membrane module 1 to flow out completely.

The procedure for using the submerged type hollow fiber membrane module 21 in FIG. 13 is described below.

For the filtration process, the air supply valve and the first drainage valve are closed while the permeate valve is opened, followed by starting the suction pump to allow raw water to flow from the openings 28 in the cylindrical case 17 to the hollow fiber membranes 22 and allow the permeate to flow out from the permeate outlet (outlet port) 33 to the permeate discharge pipe.

As in the hollow fiber membrane module 1 shown in FIG. 1, as the filtration proceeds during this process, particulate matter in raw water accumulates on the outer surface of the hollow fiber membranes 22 to increase the filtration resistance in the hollow fiber membranes 22, leading to a decrease of the water flux of the membrane. So, back washing and air scrubbing are performed.

For back washing, the suction pump-is stopped and the first drainage valve is closed, followed by keeping the permeate valve opened for a required time to allow the water to flow in the reverse direction from the inside (hollow space) of the hollow fiber membranes 22.

For air scrubbing, the suction pump is stopped and the first drainage valve and the permeate valve are closed, followed by keeping the air supply valve opened for a required time to allow air to flow into the hollow fiber membrane module 21.

Drainage is performed after the back washing and air scrubbing. For the drainage, the suction pump is stopped and water is drained from the first drainage valve and the processed water outlet provided in the reservoir (not shown in the figure).

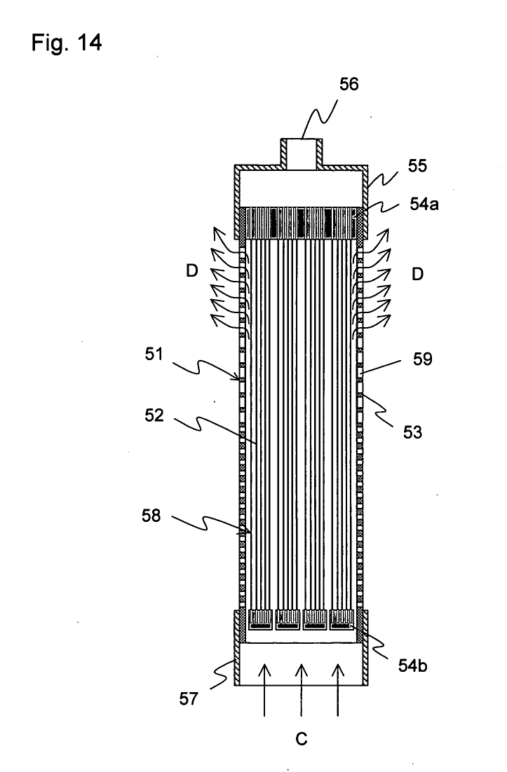

FIG. 14 shows a schematic cross-section of another example of the submerged type hollow fiber membrane module of the invention. In FIG. 14, the submerged type hollow fiber membrane module 51 comprises a cylindrical case 53 in which openings 59 are provided in the circumferential wall, and a hollow fiber membrane bundle comprising several hundreds to several tens of thousands of hollow fiber membranes 52 inserted in the cylindrical case 53. The top and bottom ends of the cylindrical case 53 are closed. The top end portions of the hollow fiber membranes 52 are fixed with the top adhesion material (top end plate) 54a. Here, the ends of the hollow fiber membranes 52 are open, and the top adhesion material (top end plate) 54a are fixed in a watertight manner to the top end portion of the cylindrical case 53.

The hollow fiber membranes 52 are divided at the bottom end portion into more than one small bundle 58. Each small bundle 58 contains several tens to several thousands of hollow fiber membranes 52. The hollow fiber membranes 52 in each small bundle 58 are fixed with the bottom adhesion member (small bundle forming member) 54b, the end of each hollow fiber membrane 52 is plugged. The bottom adhesion member (small bundle forming member) 54b is not fixed to the cylindrical case 53. The membrane area between the bottom face of the top adhesion member (top end plate) 54a and the top face of the bottom adhesion member (small bundle forming member) 54b in each hollow fiber membrane 52 works for filtration. The bottom adhesion member (small bundle forming member) 54b may have a various shapes including cylinder, sphere, cone and pyramid.

The number of the small bundles 58 and the number of the hollow fiber membranes 52 contained in a small bundle 58 may be selected appropriately to achieve required swinging motions of the small bundles 58, depending on the diameter and length of the cylindrical case 53 and the diameter of the hollow fiber membranes 52. For a hollow fiber membrane module with a diameter and a length of the cylindrical case 53 of about 50 to 400 mm and about 500 to 3000 mm, respectively, and a diameter of the hollow fiber membranes 52 of about 0.5 to 2 mm, for instance, the number of the small bundles 58 is preferably in the range of about 3 to 1000, more preferably 3 to 50. This is because a smaller number of small bundles 58 will prevent smooth discharge of particulate matter whereas the production process will be more troublesome with an increased number of the bundles though particulate matter will be discharged more smoothly.

The number of the hollow fiber membranes 52 contained in a small bundle 58 is preferably in the range of 50 to 2000. This is because a smaller number of hollow fiber membranes 52 contained in the small bundle 58 will increase the number of the small bundles 58 and, as described above, make the production process more troublesome whereas an increased number of hollow fiber membranes 52 contained in a small bundle 58 will allow more particulate matter to accumulate between the hollow fiber membranes 52.

The outer diameter of the hollow fiber membranes 52 is preferably in the range of 0.3 to 3 mm. This is because a smaller outer diameter of the hollow fiber membranes 52 will lead to breakage of and damage to hollow fiber membranes 52 when handling the hollow fiber membranes 52 during the production of the hollow fiber membrane module 51 and when performing filtration and washing during use of the hollow fiber membrane module 51, whereas a larger diameter will lead to a smaller number of hollow fiber membranes 52 that can be contained in a cylindrical case 53, resulting in a decrease in the filtration area.

The membrane thickness of the hollow fiber membranes 52 is preferably in the range of 0.1 to 1 mm. This is because a smaller membrane thickness will cause breakage of hollow fiber membranes 52 under pressure, where as a larger membrane thickness will lead to an increase of pressure loss in filtration and an increase in the material cost.

The resin to be used as the top adhesion member (top end plate) 54a and the bottom adhesion member (small bundle forming member) 54b to adhere the hollow fiber membranes 52 is preferably a polymer that is widely available, less expensive and small in influence on the water quality, such as epoxy resin, urethane resin and epoxy acrylate resin.

In FIG. 14, a water collecting cap 55 is provided at the top open end of the cylindrical case 53 to collect permeate. An skirt 57 is connected to the bottom open end of the cylindrical case 53 to supply raw water and air for washing. A permeate outlet (outlet port) 56 is provided in the water collecting cap 55.

The molding materials for the cylindrical case are used for producing the cylindrical case 53, water collecting cap 55 and skirt 57. The cylindrical case 53, water collecting cap 55 and skirt 57 may be made of the same material or different materials.

In the submerged type hollow fiber membrane module of the invention, the circumferential wall of the cylindrical case has openings. The cylindrical case 53 of the submerged type hollow fiber membrane module 51 shown in FIG. 14 has openings 59. The cylindrical case 53 is made of porous material such as mesh plate. For the openings 59 in the lower portion of the cylindrical case 53, the average aperture ratio is preferably 25% or less.

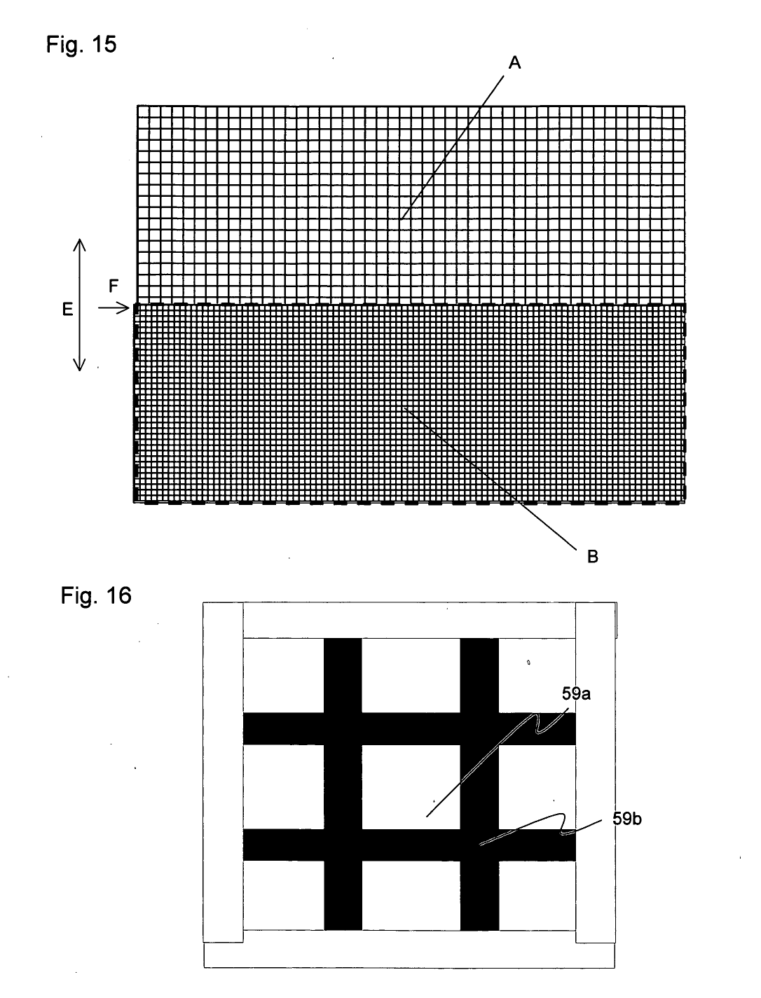

FIG. 15 shows a development of the circumferential wall, made of porous material as given in FIG. 14, of the cylindrical case 53. In FIG. 15, the circumferential wall of the lower portion of the cylindrical case 53 is made of porous material with an aperture ratio of 25% or less. The circumferential wall of the lower portion of the cylindrical case 53 is defined as the portion of the circumferential wall (region B enclosed with broken lines in FIG. 15) that is between the center (at position indicated by arrow F in FIG. 15) in the length direction (direction of arrow E in FIG. 15) of the cylindrical case 53 and the bottom adhesion member (small bundle forming member) 54b.

FIG. 16 shows an enlarged view of a portion of the circumferential wall of the cylindrical case 53. In FIG. 16, the circumferential wall consists of open portions 59a and wire portions 59b. Assuming that the projected area of the region B in the development of the circumferential wall in FIG. 15 and the total projected area of the open portions 59a are X and Y, respectively, the average rate of hole area for the lower portion (region B) is calculated by the following equation: Y/X×100(%).

The circumferential wall of the upper portion of the cylindrical case 53 is defined as the portion of the circumferential wall (region A) that is between the center (at position indicated by arrow F in FIG. 15) in the length direction (direction of arrow E in FIG. 15) of the cylindrical case 53 and the top adhesion member (top end plate) 54a. The average rate of hole area for the upper portion (region A) is also calculated by the above-mentioned equation.

The distribution of openings 59 (for position and aperture area of each opening 59) in the cylindrical case 53 may be either homogeneous or inhomogeneous in the length (vertical) direction. A distribution that is inhomogeneous in the circumferential direction is not preferred because it will cause inhomogeneous flows of raw water and air. At least some portions of the lower portion (region B) may be a plate-like material free of holes.

The average rate of hole area in the upper portion (region A) is preferably larger than that in the lower portion (region B). For instance, the average rate of hole area in the upper portion (region A) is preferably in the range of 30 to 70%, and the difference between the average rate of hole area in the upper portion (region A) and that in the lower portion (region B) is preferably more than 10%.

A cylindrical case that has a circumferential wall with an average rate of hole area as described above can be produced by, for instance, combining two porous materials with different required average rates of hole area, with one of them put on top of the other. A cylindrical case in which the average rate of hole area in the upper half is larger than that in the lower half can be prepared by, for instance, first producing the entire circumferential wall of a porous material with a required average rate of hole area and then connecting another porous material with the same or a different average rate of hole area to the bottom of the former.

Various types of plate-like material in such a form as mesh, net or punching metal can be used as the porous material in the circumferential wall of the cylindrical case. For instance, such materials include porous molded-resin plates and cylinders, nets of metal wire and punching metal plates. Among others, porous molded resins are preferred because they are generally less expensive and small in influence on the water quality.

Procedures for treating raw water with a submerged type hollow fiber membrane module-51 as shown in FIG. 14 are described below.

First, the hollow fiber membrane module 51 is immersed in a reservoir (not shown in the figure) deeper than the height of the module, with the water collecting cap 55 upward. The reservoir contains raw water that contains particulate matter. When a pump is activated for suction through the permeate outlet 56 in the water collecting cap 55 of the hollow fiber membrane module 51, raw water in the reservoir that contains particulate matter is taken into the hollow fiber membrane module 51 through the openings 59 in the cylindrical case 53 and the skirt 57 and filtered through the hollow fiber membranes 52 to produce permeate, which flows through the water collecting cap 55 and the permeate outlet 56 and gets into the water collecting pipe (not shown in the figure) During this filtration process, particulate matter in the raw water accumulates on the outer surface of the hollow fiber membranes 52. Suction of permeate allows the raw water to be filtered and taken out of the reservoir, resulting in a lowered water level in the reservoir, so raw water is supplied to the reservoir as required.

The filtration process, which is performed for a specified period of time, is followed by back washing to force permeate or compressed air to flow from the water collecting cap 55 to the raw water side, and air scrubbing to supply compressed air from the air pipe (not shown in the figure) provided below the hollow fiber membrane module 51 into the hollow fiber membrane module 51 via the skirt 57 provided at the bottom of the hollow fiber membrane module 51 to discharge particulate matter accumulated in the hollow fiber membrane module 51 out of the module.

Permeate or compressed air flows from inside the hollow fiber membranes 52 to the outside in the back washing process to remove particulate matter accumulated on the outer surface of the hollow fiber membranes 52 from the outer surface of the hollow fiber membranes 52 or to treat the particulate matter so that it can be removed easily. In the subsequent air scrubbing process, small pieces of particulate matter are discharged out of the hollow fiber membrane module 51 through the openings in the cylindrical case 53 and the skirt 57, and finally they fall to the bottom of the reservoir after flowing in the reservoir for some time.

During this process, the bottom adhesion material (bundling member) 54b is not fixed to the cylindrical case 53 in the hollow fiber membrane module 51, and air scrubbing works to allow the hollow fiber membranes 52 to swing together with the bottom adhesion member (small bundle forming member) 54b. This swinging motion serves to remove the particulate matter accumulated on outer surface of the hollow fiber membranes 52. Furthermore, as particulate matter is discharged through the bottom of the hollow fiber membrane module 51, water containing particulate matter is also discharged through the spaces between the pieces of bottom adhesion member (small bundle forming member) 54b, allowing particulate matter to flow out of the hollow fiber membrane module 51 almost completely to prevent deterioration in the filtration ability. The particulate matter accumulated at the bottom of the reservoir is released out of the reservoir during the regular discharge of raw water out of the reservoir.

These processes are repeated to continue filtration of raw water for a long period of time.

The flow of air in the hollow fiber membrane module 51 during the air scrubbing process is described below.

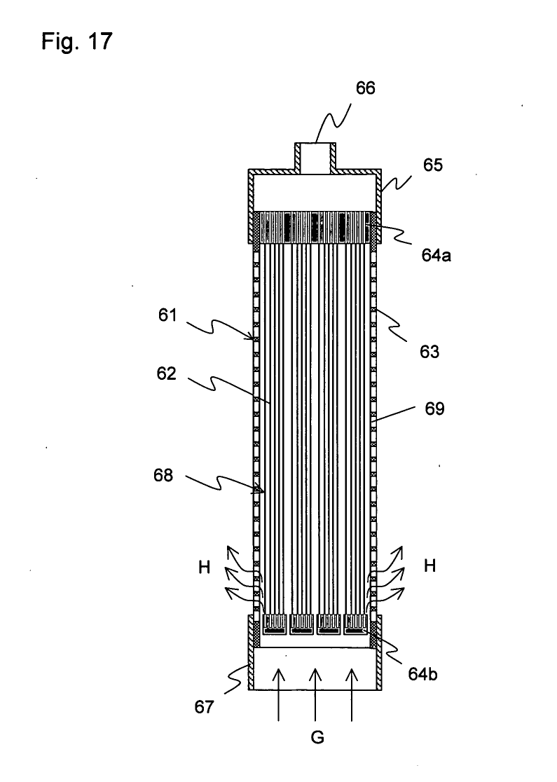

FIG. 17 shows a schematic cross-section of a submerged type hollow fiber membrane module that is substantially of the same type as the submerged type hollow fiber membrane module 21 shown in FIG. 13. In FIG. 17, the submerged type hollow fiber membrane module 61 comprises a cylindrical case 63, in which openings 69 are provided in the circumferential wall, and a hollow fiber membrane bundle comprising a large number of hollow fiber membranes 62 inserted in a cylindrical case 63. Both the top and bottom ends of the cylindrical case 63 are open. The top end portion of the hollow fiber membranes 62 are fixed with a top adhesion member (top end plate) 64a, with the ends of the hollow fiber membranes 62 being left open, and the top adhesion member (top end plate) 64a is fixed to the top end portion of the cylindrical case 63 in a water tight manner.

The hollow fiber membranes 62 at the bottom end portion are divided into more than one small bundle 68. Each small bundle 68 contains more than one hollow fiber membrane 62. The hollow fiber membranes 62 in each small bundle 68 are fixed with the bottom adhesion member (small bundle forming member) 64b, and the end of each hollow fiber membrane 62 is plugged. The bottom adhesion member (small bundle forming member) 64b is not fixed to the cylindrical case 63. A membrane area located between the bottom face of the top adhesion member (top end plate) 64a and the top face of the bottom adhesion member (small bundle forming member) 64b in the hollow fiber membranes 62 serves for filtration area.

In FIG. 17, compressed air supplied through an air pipe, not shown in the figure, provided below the hollow fiber membrane module 61 is taken in the direction of the arrows G into the hollow fiber membrane module 61 via the skirt 67 (which corresponds to the bottom cap 27 in FIG. 13). Most of the air taken flows out of the hollow fiber membrane module 61 through openings 69 provided in the circumferential wall of the cylindrical case 63 in the lower portion of the hollow fiber membrane module 61 as indicated by the arrows H. Thus the compressed air acts to swing those portions of the hollow fiber membranes 62 which are located in the lower portion of the hollow fiber membrane module 61 to allow particulate matter to be easily removed from the outer surface, but those portions of the hollow fiber membranes 62 which are located in the upper portion of the hollow fiber membrane module 61 do not swing sufficiently because only a small amount of compressed air is supplied. Particulate matter on the outer surface of the upper portions of the hollow fiber membranes 62 may be removed by such swinging motions if the compressed air supply is increased, but this will require an increased running cost for water treatment.

The rate of hole area in the circumferential wall of the cylindrical case 53 in the lower portion of the hollow fiber membrane module 51 shown in FIG. 14 is as low as 25% or less, and as shown in FIG. 14, compressed air taken into the hollow fiber membrane module 51 via the skirt 57 in the direction of the arrows C flows out only a little through the openings 59 in the circumferential wall of the cylindrical case 53 in the lower portion of the hollow fiber membrane module 51. This allows the entire length of the hollow fiber membranes 52 to swing sufficiently, and the air reaches the top portion of the hollow fiber membrane module 51 and flows out through the openings 59 in the upper portion as indicated by the arrows D.

Thus, compressed air can be used more efficiently and the required running cost is smaller for the submerged type hollow fiber membrane module 51 shown in FIG. 14 than the submerged type hollow fiber membrane module 61 in FIG. 17 and the submerged type hollow fiber membrane module 21 in FIG. 13. Similar to compressed air, particulate matter also flows out only a little through openings 59 in the cylindrical case 53 in the lower portion of the hollow fiber membrane module 51. As described above, there is no problem with particulate matter because it is discharged out of the hollow fiber membrane module 51 after flowing into the skirt 57 through the spaces between the pieces of the bottom adhesion material (small bundle forming member) 54b.

In the submerged type hollow fiber membrane module 51 shown in FIG. 14, furthermore, the average rate of hole area for the upper portion (region A) of the circumferential wall of the cylindrical case 53 is preferably larger than that for the lower portion (region B) of the circumferential wall as illustrated in FIG. 15. In this embodiment, particulate matter removed from the outer surface of the hollow fiber membranes during the air scrubbing process is carried by the upward flow caused by the compressed air in the hollow fiber membrane module 51, moving out of the hollow fiber membrane module 51 through portions with a high average rate of hole area in the circumferential wall of the cylindrical case 53 in the upper portion of the hollow fiber membrane module 51.

In another practical embodiment of the submerged type hollow fiber membrane module of the invention, a configuration of cylindrical case (not shown in the figure) in a module has a projected area of openings in the circumferential wall of the cylindrical case, which increases continuously or stepwise in the upward direction from the bottom toward the top.

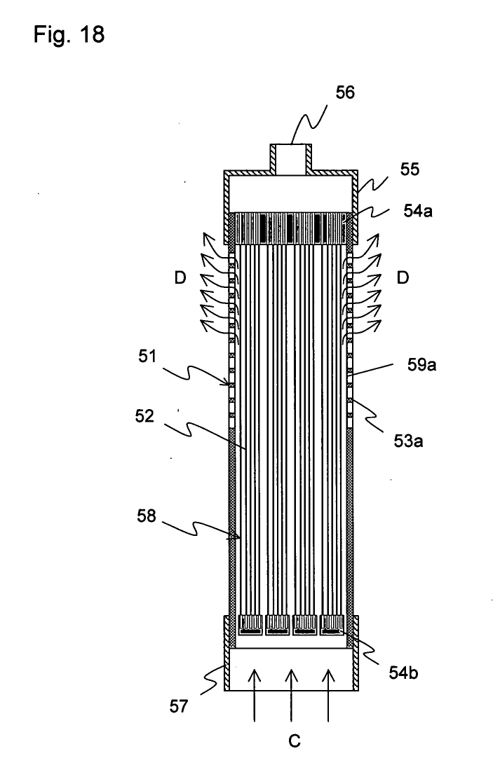

FIG. 18 shows a schematic cross-section of still another embodiment of the submerged type hollow fiber membrane module of the invention. The difference between the module 51 in FIG. 18 and that in FIG. 14 is that the cylindrical case 53a of the module 51 shown in FIG. 18 has no openings 59a in the lower portion (region B) of the cylindrical case 53a (average rate of hole area of zero).

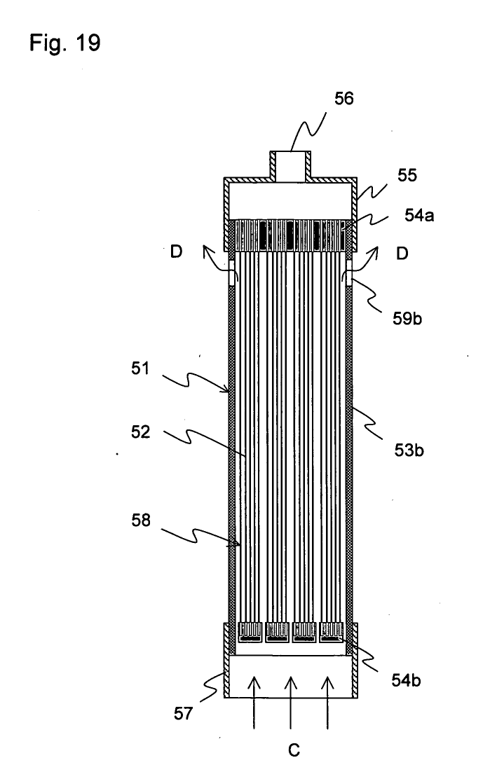

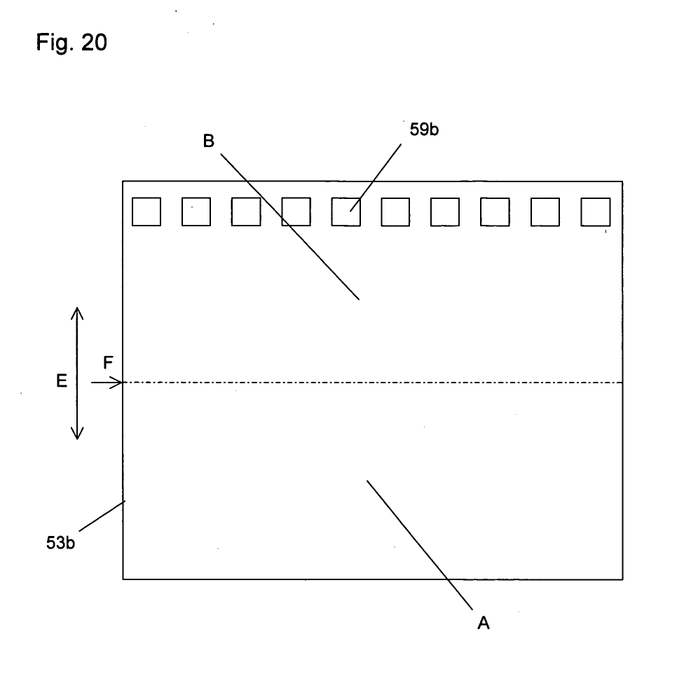

FIG. 19 shows a schematic cross-section of still another embodiment of the submerged type hollow fiber membrane module of the invention. The difference between the module 51 in FIG. 19 and that in FIG. 18 is that the cylindrical case 53b of the module 51 shown in FIG. 199 has openings 59b only in a limited part of the upper portion (region A) of the cylindrical case 53b. FIG. 20 shows a development of the circumferential wall of the cylindrical case 53b of the module 51 shown in FIG. 19. In this module, the openings 59b provided only in a limited part of the upper portion of the cylindrical case 53b are the only outlet for the compressed air supplied from below the module 51, allowing the compressed air to work efficiently to swing the hollow fiber membranes 52. On the other hand, this decreases the amount of particulate matter discharged through the circumferential wall of the cylindrical case 51.

The openings 59a and 59b shown in FIG. 16 and FIG. 20, respectively, have a rectangular shape, but these openings may have other shapes including polygons such as triangle, pentagon and hexagon, and other shapes such as circle, ellipse and star. More than one of these shapes may coexist.

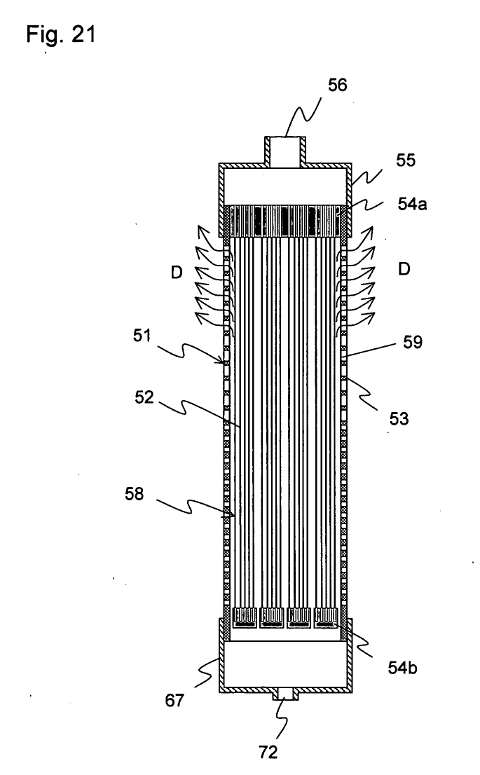

FIG. 21 shows a schematic cross-section of still another embodiment of the submerged type hollow fiber membrane module of the invention. The difference between the module 51 in FIG. 21 and that in FIG. 14 is that the bottom cap 67 having an air supply pipe 72 is provided, instead of the skirt 57 shown in FIG. 14, in the bottom end portion of the cylindrical case 53 of the module 51 given in FIG. 21.

### EXAMPLE 1

The hollow fiber membrane module 1 shown in FIG. 1 was used to filter water taken from Lake Biwa, followed by back washing, air scrubbing and discharge.

Lake water was supplied by a pump to the module 1 at 83 liters/m²·hr, and filtered for 30 minutes, and then 100 liters of the permeate was used to carry out back washing of the hollow fiber membranes 2. Air was blown into the module 1 through the inlet port 12 at 200 liters/min for 1 min, and then the water was discharged. This cycle of filtration, back washing, air scrubbing and discharge was performed repeatedly.

As the hollow fiber membranes 2, 9000 porous hollow fiber membranes made of polyvinylidene fluoride having an outer diameter of 1.5 mm, inner diameter of 0.9 mm and length of 1870 mm were used. A cylindrical case of polyvinyl chloride resin having an inner diameter of 193 mm and length 2000 mm was used as the cylindrical case 3.

Epoxy resin was used for the synthetic polymer resin (top end plate) 4 and the plugging member (small bundle forming member) 5. The plugging member (small bundle forming member) 5 used had a cylindrical shape, and bundled 420 to 430 of the hollow fiber membranes 2 into a small bundle 2a, and for each small bundle 2a, the ends of the hollow fiber membranes 2 were plugged with the epoxy resin.

The above-mentioned cycle of operations was performed repeatedly using the module 1 for 22 days, but the difference between the pressure in the cylindrical case 3 and that in the top cap 6 was always below 150 kPa.

### COMPARATIVE EXAMPLE 1

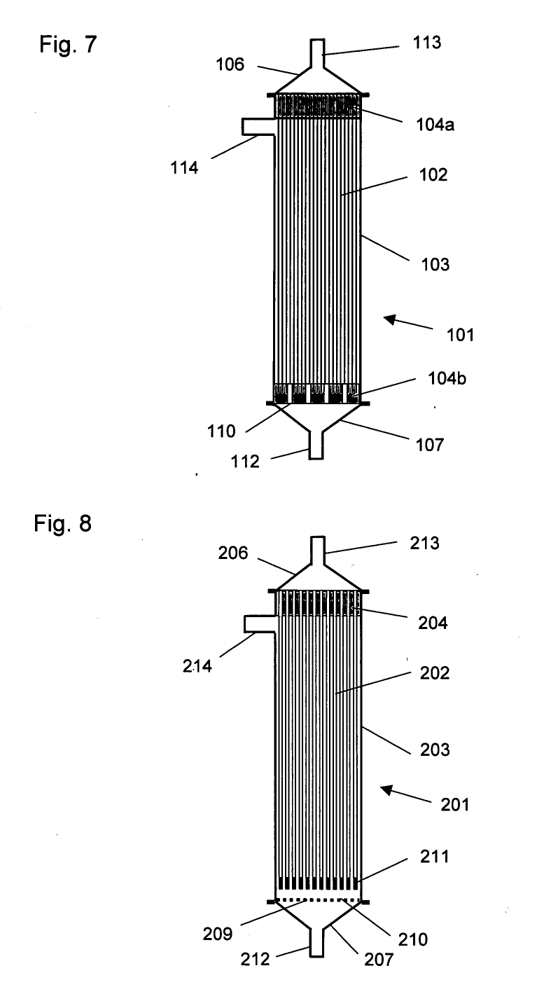

The same procedure as in Example 1 was carried out to repeat the cycle of filtration, back washing, air scrubbing and discharge except that both ends of the hollow fiber membranes 2 were fixed to the cylindrical case 3 with the synthetic polymer resin 4 as shown in FIG. 7.

The above-mentioned cycle of operations was performed repeatedly using the module 1, and the difference between the pressure in the cylindrical case 3 and that in the top cap 6 reached was 150 kPa on the 7th day.

### EXAMPLE 2

The same procedure as in Example 1 was carried out to repeat the cycle of filtration, back washing, air scrubbing and discharge except that the conditions were changed as described under (1) to (4) below, and the process of scale removal from the hollow fiber membranes 2 in the transparent case (see condition (2) describe below) was observed.

### COMPARATIVE EXAMPLE 2

The same procedure as in Comparative example 1 was carried out to repeat the cycle of filtration, back washing, air scrubbing and discharge except that the conditions were changed as described under (1) to (4) below, and the process of scale removal from the hollow fiber membranes in the transparent case (see condition (2) describe below) was observed.

(1) The number of the hollow fiber membranes 2 was changed to 1800.

(2) A transparent cylindrical case of acrylic resin having an inner diameter of 100 mm and length of 1000 mm was used as the cylindrical case 3.

(3) A 60 liter volume of permeate water produced by RO membrane filtration containing 1000 ppm of ferric hydroxide was used as raw water, which was supplied at a rate of 83 liters/m²·hr to perform recirculation filtration for one hour to allow ferric hydroxide to accumulate to cover apparently the entire membrane. The amount of accumulated ferric hydroxide was estimated based on the color of the surface of the hollow fiber membranes.

(4) Air scrubbing was performed at an air supply rate of 20 liters/min for 30 seconds, and back washing was not performed.

Results showed that the color of the outer surface of the hollow fiber membranes of the hollow fiber membrane module in Example 2 is generally lighter than that in Comparative example 2, indicating that ferric hydroxide on the membrane was removed more effectively.

### EXAMPLE 3

A permeate pipe was connected to the permeate outlet 56 in the hollow fiber membrane module 51 shown in FIG. 14, and the hollow fiber membrane module 51 was immersed, with the permeate outlet 56 upward, in a reservoir containing raw water, followed by suction by a pump from the water collecting cap 55 side to carry out filtration of the raw water in the reservoir.

Porous hollow fiber membranes of polyvinylidene fluoride having an outer diameter of 0.9 mm and length of about 1000 mm were used as the hollow fiber membranes 52 in the hollow fiber membrane module 51. About 10000 hollow fiber membranes were inserted in the cylindrical case 53. The cylindrical case 53, made of polyethylene, had an inner diameter of about 135 mm and length of about 1000 mm, and the rate of hole area was 25% and 37.5% in the lower portion (region B) and the upper portion (region A), respectively, of the circumferential wall. The shape of the openings 59 was a square (3mm×3 mm) in the lower portion (region B) and a rectangle (3 mm×9 mm) in the upper portion (region A). To provide the openings 59, mesh plates made of 3 mm thick wire were used in both the regions A and B. Urethane resin was used for both the top adhesion member (top end plate) 54a and the bottom adhesion member (small bundle forming member) 54b. The bottom adhesion member (small bundle forming member) 54b had a cylindrical shape. About 1400 of the hollow fiber membranes 52 were bundled, and their ends were plugged with the urethane resin. Seven small bundles 58 (bottom adhesion member (small bundle forming member)) were produced.

Then, water having a turbidity of 3 to 5 taken from Lake Biwa was used as raw water, and a pump was used to perform suction from the water collecting cap 55 side for 30 min to produce permeate at 0.5 m³/m²/day, followed by back washing performed for 1 min at a permeate flow rate of 1 m³/m²/day and air scrubbing conducted for 1 min to blow compressed air into the hollow fiber membrane module 51 through the skirt 57 at a rate of 100 liters/min. The raw water in the reservoir was discharged one time per every few times of repeating of the cycle of filtration, back washing and air scrubbing. This operation was continued for about one week, during which no increase of pressure loss of the hollow fiber membranes was observed.

### COMPARATIVE EXAMPLE 3

Using the same hollow fiber membrane module as in Example 3 except that the average rate of hole area in the circumferential wall of the cylindrical case 53 was 30% over the entire circumferential wall was used, and the same procedure was carried out for one week filtration of raw water. Results showed that the pressure loss of the hollow fiber membranes was increased at a rate of 1 kPa/day.

### EXAMPLE 4

A filtration of row water was performed with the hollow fiber membrane module shown in FIG. 11.

As the hollow fiber membranes 2, 3000 porous hollow fiber membranes made of polyvinylidene fluoride having an outer diameter of 1.5 mm, inner diameter of 0.9 mm and length of 1000 mm were used. A cylindrical case of ABS resin having an inner diameter of 130 mm and length about 1000 mm was used as the cylindrical case 3. Urethane resin was used for the top end plate 4 and the small bundle forming member 5. The small bundle forming member 5 used had a cylindrical shape, and bundled 420 to 430 of the hollow fiber membranes 2 into a small bundle 2a, and the end of each hollow fiber membranes 2 was plugged.

As the hanging string 2b, a stainless wire having a diameter of 0.5 mm was used. In each of the small bundle 2a, there were hollow fiber membranes having the shortest lengths (in stretched straight) in the filtration area, of in the range of 998 mm to 1001 mm, to those situations the lengths excluding of portions in the top end plate 4 and the small bundle forming member 5 (i.e. the length of the filtration area) (in stretched straight) of the stainless wires were determined in the range of 988 mm to 990 mm, respectively.

The hollow fiber membrane module 1 shown in FIG. 1 was used to filter water taken from Lake Biwa, followed by back washing, air scrubbing and discharge.

Lake Biwa water as raw water was supplied by a pump to the module 1 at 40 liters/m²·hr, and filtered for 30 minutes, and then back washing was carried out with the permeate at 60 liters/m² hr and air feeding from the inlet port 12 into the module 1 was carried out with air at 100 liters/min and then the water was discharged also from the inlet port 12. This cycle of filtration, back washing, air scrubbing and discharge was performed repeatedly.

After the lapse of 12 months, a break of the hollow fiber membrane was not recognized by a break membrane inspection.

### COMPARATIVE EXAMPLE 4

Using the same hollow fiber membrane module as in Example 4 except that the hanging strings in the small bundles were not provided. Results showed that in a break membrane inspection at after the lapse of about 6 months, it was found that one hollow fiber membrane was broken, and then a clogging operation of the broken hollow fiber membrane with a resin was performed.

In the hollow fiber membrane module of the invention, a large number of hollow fiber membranes contained in a cylindrical case hang from the top of the cylindrical case in a state that the bottom end portions of the large number of hollow fiber membranes in the cylindrical case are divided into more than one small bundles, and therefore, the small bundles can swing as raw water flows or as air flows during air scrubbing, allowing the particulate matter accumulated on the outer surface of the hollow fiber membranes to be removed as a result of the swinging motions of the small bundles. So, the hollow fiber membrane module of the invention can work for a longer period of time than conventional hollow fiber membrane modules.

1. A hollow fiber membrane module, which comprises a hollow fiber membrane bundle comprising a large number of hollow fiber membranes, contained in a cylindrical case, wherein one end portion of the hollow fiber membrane bundle is fixed to the cylindrical case in a state that end of each end of the hollow fiber membranes is open, while at the other end portion of the hollow fiber membrane bundle, the large number of hollow fiber membranes are divided into small bundles, with each small bundle being composed a plurality of the hollow fiber membranes, and with a small bundle forming member being provided at the end portion of each of the small bundles in order to bundle and fix the hollow fiber membranes and close the end of each of the hollow fiber membranes.

2. A hollow fiber membrane module according to claim 1, wherein the number of the small bundles is in the range of 10 to 800.

3. A hollow fiber membrane module according to claim 1, wherein the diameter of the module is in the range of 50 to 400 mm, the length of the module is in the range of 500 to 3000 mm, and the number of the hollow fiber membranes contained in each small bundle is in the range of 50 to 800.

4. A hollow fiber membrane module according to claim 1, wherein a turbulence generation member is provided on the surface of the small bundle forming member.

5. A hollow fiber membrane module according to claim 1, wherein a small bundle partition member is provided in the cylindrical case, and the small bundle forming member is compartmentalized by the small bundle partition members.

6. A hollow fiber membrane module according to claim 1, wherein at least one hanging string is provided along with the hollow fiber membranes forming each of the small bundles, and one end of the hanging string is fixed at cylindrical case together with the one ends of the hollow fiber membranes and the other end of the hanging string is fixed at the small bundle forming member together with the hollow fiber membranes forming the small bundle, and wherein in each of the small bundle, a length of the hanging string in a filtration area is shorter than the shortest length of the hollow fiber membrane among lengths of the hollow fiber membranes in the filtration area.

7. A hollow fiber membrane module according to claim 1, wherein the cylindrical case has an opening to allow water to move between inside and outside thereof.

8. A hollow fiber membrane module according to claim 7, wherein the opening is formed by providing porous material in at least parts of the circumferential wall of the cylindrical case, and the average rate of hole area in the lower portion of the circumferential wall of the cylindrical case is 25% or less.

9. A hollow fiber membrane module according to claim 8, wherein the average rate of hole area of in the upper portion of the circumferential wall of the cylindrical case is larger than the average rate of hole area in the lower portion of the circumferential wall.

10. A hollow fiber membrane module according to claim 7, wherein the number of the small bundles is in the range of 3 to 50, and the number of the hollow fiber membranes in each of the small bundles is in the range of 50 to 2000.
